(19) United States
(12) Patent Application Publication
(10) Pub. No.: US 2010/0040076 A1
(43) Pub. Date: Feb. 18, 2010

(54) NETWORK DEVICE AND METHOD FOR PROCESSING DATA PACKETS

(75) Inventors: CHING-HUI LI, Tu-Cheng (TW); YAO-HONG DU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen)CO., Ltd, Shenzhen City (CN); HON HAI PRECISION INDUSTRY CO., LTD., Tu-Cheng (TW)

(21) Appl. No.: 12/417,651

(22) Filed: Apr. 3, 2009

(30) Foreign Application Priority Data
Aug. 14, 2008 (CN) 200810303773.1

(51) Int. Cl. H04L 12/56

(52) U.S. Cl. 370/412

(57) ABSTRACT

A network device for processing data packets receives data packets from networks connected to the network device, searches a rule table for data packet matching conditions corresponding to the data packets, and transmits the data packets to corresponding data packet targets. The network device further retrieves matching actions corresponding to the data packets, transmits the data packets and the corresponding matching actions to the user daemon thread module, and further transmits the data packets to corresponding daemon threads according to the corresponding matching actions.

### BACKGROUND

1. Technical Field

The disclosure relates to network devices, and particularly to a network device and method for processing data packets.

2. Description of Related Art

Linux systems, as open source code systems, have low costs and high flexibility and are therefore popularly used as embedded systems in electronic devices, such as set top boxes and mobile devices.

A netfilter is a key element of the Linux systems for retrieving data packets with user wanted information from the network. However, the netfilter can only process actions of accepting, dropping, and rejecting. That is, the netfilter can only process limited data packets.

### BRIEF DESCRIPTION OF THE DRAWINGS

FIG. 1 is a schematic diagram of a network device of the present disclosure.

FIG. 2 is a flow chart of one embodiment of a method for processing data packets as disclosed.

### DETAILED DESCRIPTION

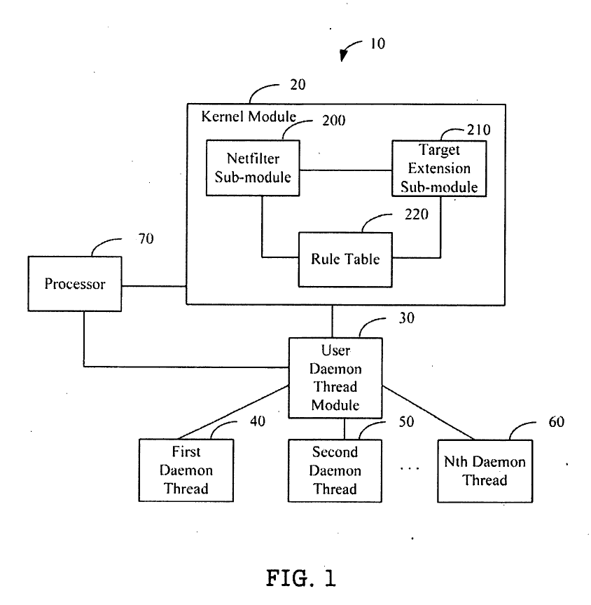

FIG. 1 is a schematic diagram of a network device 10 of the present disclosure. In one embodiment, the network device 10 may run a Linux-based operating system (OS) for processing data packets, and may be a dynamic host configuration protocol (DHCP) server or router. The network device 10 includes a user daemon thread module 30 and a kernel module 20. The kernel module 20 is configured for providing working programs of the network device 10, such as, driver programs, and includes a netfilter sub-module 200, a target extension sub-module 210, and a rule table 220.

The rule table 220 includes a plurality of data packet matching conditions, a plurality of corresponding data packet targets, and a plurality of corresponding matching actions. In one embodiment, the plurality of data packet matching conditions include source Internet protocol (IP) addresses of data packets. It is appreciated that the plurality of data packet matching conditions may also include destination IP addresses or source IP ports of data packets. Data packets will be sent to the plurality of data packet targets, which include the target extension sub-module 210. Accordingly, the plurality of data packet targets perform one or more operations on the data packets according to the plurality of matching conditions. Matching actions corresponding to the target extension sub-module 210 include commands to process the matching actions corresponding to the target extension sub-module 210. For example, if data packet matching conditions are source IP addresses of data packets, a data packet target corresponding to a source IP address being 192.168.10.1 of data packets is the target extension sub-module 210, and a corresponding matching action is a forwarding command. Thus, data packets with source IP addresses of 192.168.10.1 is transmitted to the target extension sub-module 210 to execute the forwarding command. Here, the rule table 220 can be set according to users' actual needs.

The netfilter sub-module 200 is configured for receiving data packets from networks connected to the network device 10, and transmitting the data packets according to the rule table 220. The netfilter sub-module 200 searches the rule table 220 for a data packet matching condition corresponding to a received data packet, and transmits the received data packet to a data packet target corresponding to the found data packet matching condition. If the received data packet matches a data packet matching condition corresponding to the target extension sub-module 210, the netfilter sub-module 200 transmits the received data packet to the target extension sub-module 210.

The target extension sub-module 210 is configured for receiving the data packets from the netfilter sub-module 2100, retrieving matching actions corresponding to the received data packets, and transmitting the received data packets and the corresponding matching actions to the user daemon thread module 30. Here, the user daemon thread module 30 is a user space program connected to the target extension sub-module 210, such as by netlink.

The user daemon thread module 30 includes a plurality of daemon threads, such as a first daemon thread 40, a second daemon thread 50, and an Nth daemon thread 60. The user daemon thread module 30 is configured for receiving the data packets and the corresponding matching actions from the target extension sub-module 210 and transmitting the data packets to a corresponding daemon thread to process according to the corresponding matching actions. The user daemon thread module 30 is further configured for determining if there is a daemon thread corresponding to the corresponding matching actions. The user daemon thread module 30 sends the data packets to the corresponding daemon thread to process upon the condition that there is a corresponding daemon thread. Otherwise, the user daemon thread module 30 sets a new daemon thread according to the corresponding actions, and sends the data packets to the new daemon thread to process. The plurality of daemon threads can process different data packets and perform different actions.

Here, the network device 10 further includes at least one specialized or general purpose processor, such as a processor 70 for executing one or more computerized instructions for the kernel module 20 and the user daemon thread module 30.

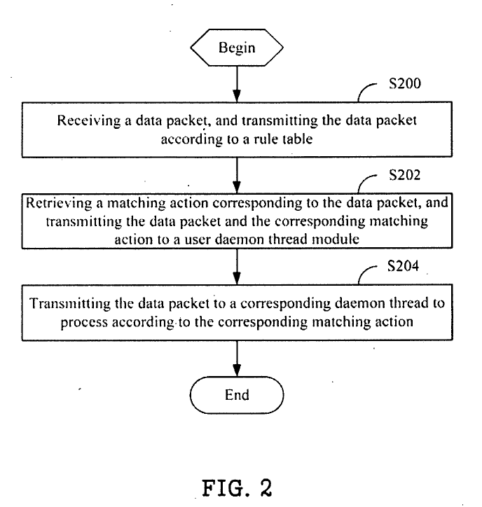

FIG. 2 is flow chart of the disclosed method for processing data packets of the network device 10. In block S200, the netfilter sub-module 200 receives a data packet from a network connected to the network device 10, and transmits the data packet according to the rule table 220. In this embodiment, the netfilter sub-module 200 searches the rule table 220 for a data packet matching condition corresponding to the data packet, and transmits the data packet to a corresponding data packet target. In block S202, the target extension sub-module 210 receives the data packet from the netfilter sub-module 200, retrieves a matching action corresponding to the data packet from the rule table 220, and transmits the data packet and the corresponding matching action to the user daemon thread module 30.

In block S204, the user daemon thread module 30 receives the data packet and the corresponding matching action, and sends the data packet to a corresponding daemon thread to process according to the corresponding matching action. Here, the user daemon thread module 30 further determines if there is a daemon thread corresponding to the corresponding matching action. The user daemon thread module 30 sends the data packet to the corresponding daemon thread to process upon the condition that there is a corresponding daemon thread. Otherwise, the user daemon thread module 30 sets a new daemon thread according to the corresponding matching action, and sends the data packet to the new daemon thread to process.

Still referred to the above example, data packet matching conditions are source IP addresses of data packets, and the rule table 220 includes a data packet matching condition being 192.168.10.1, a corresponding data packet target being the target extension sub-module 210, and a corresponding matching action being forwarding. When the netfilter sub-module 200 receives a data packet with a source IP address being 192.168.10.1, searches the rule table 220, finds the data packet matching condition of 192.168.10.1, and transmits the data packet to the target extension sub-module 210, the corresponding data packet target. The target extension sub-module 210 retrieves the forwarding action from the rule table 220, and transmits the data packet and the forwarding action to the user daemon thread module 30. The user daemon thread module 30 sends the data packet to a forwarding daemon thread to forward the data packet. Thus, the data packet is transmitted to user space programs to process.

The network device 10 can match data packets to programs or daemon threads via the rule table 220, thus, data packets can be transmitted to user space programs to process. Therefore, loading of the kernel module 20 is reduced. Even if there is a mistake with the user daemon thread module 30, there is no effect to the kernel module 20, which helps keep the network device 10 from breaking down. In addition, users can write the threads in the user daemon thread module 30 via different languages, which is a flexible attribute.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A network device for processing data packets, comprising:
a user daemon thread module, comprising a plurality of daemon threads;
a kernel module, comprising:
a rule table, comprising a plurality of data packet matching conditions, a plurality of corresponding data packet targets, and a plurality of corresponding matching actions;
a netfilter sub-module configured for receiving data packets from a network connected to the network device, searching the rule table for data packet matching conditions corresponding to the data packets, and transmitting the data packets to data packet targets corresponding to found data packet matching conditions; and
a target extension sub-module configured for receiving the data packets from the netfilter sub-module, retrieving matching actions corresponding to the received data packets from the rule table, and transmitting the received data packets and the corresponding matching actions to the user daemon thread module; and
a processor configured for executing one or more computerized instructions for the kernel module and the user daemon thread module;
wherein the user daemon thread module is configured for transmitting the data packets to corresponding daemon threads for processing according to the corresponding matching actions.

2. The network device of claim 1, wherein the plurality of data packet matching conditions comprise source Internet protocol (IP) addresses of the data packets.

3. The network device of claim 1, wherein the plurality of data packet matching conditions comprise source IP ports of the data packets.

4. The network device of claim 1, wherein the plurality of data packet targets comprise the target extension sub-module.

5. The network device of claim 4, wherein matching actions corresponding to the target extension sub-module comprise commands to process the matching actions corresponding to the target extension sub-module.

6. The network device of claim 1, wherein the user daemon thread module is a user space program connected to the target extension sub-module.

7. The network device of claim 1, wherein the user daemon thread module is further configured for determining if there are daemon threads corresponding to the matching actions.

8. The network device of claim 7, wherein the user daemon thread module is configured for setting a new daemon thread according to the matching actions, and sending the data packets to the new daemon thread to process upon the condition that there are no daemon threads corresponding to the matching actions.

9. A method for processing data packets in a network device, comprising:
receiving a data packet from a network connected to the network device, searching a rule table for a data packet matching condition corresponding to the data packet, and transmitting the data packet to a data packet target corresponding to a found data packet matching condition;
retrieving a matching action corresponding to the data packet from the rule table, and transmitting the data packet and the corresponding matching action to a user daemon thread module; and
transmitting the data packet to a corresponding daemon thread to process according to the corresponding matching action.

10. The method for processing data packets of claim 9, further comprising:
determining if there is a daemon thread corresponding to the corresponding matching action.

11. The method for processing data packets of claim 10, further comprising:
setting a new daemon thread according to the corresponding matching action, and transmitting the data packet to the new daemon thread to process upon the condition that there are no daemon threads corresponding to the corresponding matching action.
